(19) United States
(12) Patent Application Publication
(10) Pub. No.: US 2024/0289308 A1
(43) Pub. Date: Aug. 29, 2024

(54) MIGRATION PLANNING WITH AUTOMATED DISCOVERY OF SOURCE ASSETS

(71) Applicant: International Business Machines Corporation, Armonk, NY (US)

(72) Inventors: Vaibhav Sudhakar Dantale, Pune (IN); Ashwini Ramani, Bangalore (IN)

(73) Assignee: International Business Machines Corporation, Armonk, NY (US)

(21) Appl. No.: 18/114,511

(22) Filed: Feb. 27, 2023

(51) Int. Cl. G06F 16/21; G06F 16/25

(52) U.S. Cl. CPC G06F 16/214; G06F 16/254

(57) ABSTRACT

An embodiment includes generating source inventory data representative of information technology assets associated with a source site, the source site comprising information technology infrastructure of an enterprise, the information technology assets comprising a source application database and a source peripheral entity associated with the source application database. The embodiment determines a target platform for migrating the source application database and determining a degree of compatibility between the source peripheral entity and the target platform. The embodiment creates a migration plan defining characteristics of a migration of the source application database from the source site to the target platform, wherein the target platform is selected from among a plurality of candidate target platforms based at least in part on the degree of compatibility between the source peripheral entity and the target platform.

### BACKGROUND

The present invention relates generally to data storage management and data migration. More particularly, the present invention relates to a method, system, and computer program for migration planning with automated discovery of source assets.

Data management is a key aspect of business and research in many industries, from healthcare and science, to music, cybersecurity, transportation, and many others. Managed data may be found in many different types of data storage, with common examples including databases, data warehouses, and data lakes. Proper care and use of such data often involves various peripheral systems that make up a data landscape. The types and numbers of peripheral systems that make up a data landscape will vary depending on several factors, such as the type of data storage and the purpose of the data, or how the data is being used or analyzed.

Common examples of peripheral systems include security systems, backup systems, and administrative systems, to name a few. Such peripheral systems may allow for performing administrative tasks on the data, creating backups of the data, or securing the data. Other peripheral systems may involve development and production of applications that use and/or generate the data. Still other peripheral systems may involve aspects of the data storage infrastructure, such as managing the storage software or hardware, monitoring the flow of data in and out of the data storage, or configuring high availability (HA) systems that are designed to minimize the down time of the data storage system.

### SUMMARY

The illustrative embodiments provide for migration planning with automated discovery of source assets. An embodiment includes generating source inventory data representative of information technology assets associated with a source site, the source site comprising information technology infrastructure of an enterprise, the information technology assets comprising a source application database and a source peripheral entity associated with the source application database. The embodiment also includes determining a target platform for migrating the source application database. The embodiment also includes determining a degree of compatibility between the source peripheral entity and the target platform. The embodiment also includes creating, by a processor-based migration management system, a migration plan defining characteristics of a migration of the source application database from the source site to the target platform, where the target platform is selected from among a plurality of candidate target platforms based at least in part on the degree of compatibility between the source peripheral entity and the target platform. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an exemplary migration environment for a migration management system in accordance with an illustrative embodiment;

FIG. 3 depicts a block diagram of an example service infrastructure in accordance with an illustrative embodiment;

FIG. 4 depicts a block diagram of an example source infrastructure in accordance with an illustrative embodiment;

FIG. 5 depicts a block diagram of a migration management module in accordance with an illustrative embodiment;

FIG. 6 depicts a block diagram of an automated unified discovery engine (AUDE) in accordance with an illustrative embodiment;

FIG. 7 depicts a flowchart of an example process for migration planning with automated discovery of source assets in accordance with an illustrative embodiment; and

FIG. 8 depicts a flowchart of an example process for automated discovery of source assets in accordance with an illustrative embodiment.

### DETAILED DESCRIPTION

From time to time, as a company grows or its Information technology (IT) infrastructure ages, it becomes advantageous to migrate to newer technologies. For example, in recent years, many businesses have been migrating data storage and applications to cloud environments. When such a migration is performed correctly, the result often includes such benefits as cost savings, agility increases, availability of new services, simplification of management, decreased maintenance, and increased computational resource allocation for operating applications and application workloads. However, data migration can be, depending on the scale and scope, a long and involved process.

One of the keys to a successful data migration is obtaining a complete and thorough understanding of the source landscape. The term “source” as used herein (e.g., source landscape, source infrastructure, etc.) refers to what is in place prior to migration. Thus, the source landscape refers to legacy infrastructure, including legacy data storage and multiple heterogenous peripheral systems, such as applications, storage infrastructure, backup/restore tools, and security tools, among others. Source discovery refers to the process of collecting information about the legacy infrastructure, usually as part of a planning phase in preparation for migration.

Source discovery remains a mostly manual process that is a cumbersome and time-consuming endeavor. The scope of a migration plan may involve migration of tens of thousands of servers with millions of connections between them. Manually devising a migration plan, including the discovery process that includes identifying critical dependencies among the servers and other dependencies between the servers and their components, often causes delays in data migration projects as it may take weeks or months to complete, and introduces the potential for human error. Incomplete or inaccurate information about a source landscape may lead to computing environment selections that result in an under allocation of computing resources (which, in turn, results in decreased performance), an over allocation of computing resources (which, in turn, results in computational waste and cost over runs), inefficient allocation of capital, etc. as the variables associated with environment selection are many, sometimes conflicting, and are based on uniformed or misinformed assumptions regarding the operation of source infrastructure.

Illustrative embodiments recognize that there is a need to improve data migration processes by expanding automated aspects of the source landscape discovery and target recommendation aspects, as well as improved integration of such automated aspects. Examples consistent with the present disclosure may include thorough and accurate source discovery that allows for proper prioritizations during the migration process, optimal selection of target database technology, and appropriate definition of a state architecture for the target landscape, resulting in optimized migrations plans.

Illustrative embodiments may collect and produce a variety of source inventory data descriptive of assets included in a source landscape, where the assets of the source landscape include a source application database and one or more source peripheral entities. Examples of source peripheral entities may include one or more of an application, an ETL system, a backup system, a database monitoring system, a storage system, a security system, a high-availability system, a software development and IT operations (DevOps) system, an administration system, and an underlying infrastructure. The source landscape data may be utilized to analytically determine a migration plan that extracts a maximum benefit from available choices while minimizing negative variables such as cost, and leaving availability, compliance, and/or governance intact.

Illustrative embodiments may leverage artificial intelligence technologies for discovery aspects that improve the accuracy and completeness of collected data, thereby reducing system downtime and instances of system outages and errors otherwise stemming from compatibility issues. Also, the resulting systems incorporated into the target landscape are improved over potential alternatives due to optimization of technological compatibilities during the technology selection phase of the migration.

In an illustrative embodiment, a user device initiates a migration process by issuing a migration request that is received by a user interface of a migration management module. Responsive to the migration request, an automated unified discovery engine (AUDE) collects source inventory data descriptive of assets included in a source infrastructure. The source inventory data may include details of implemented features of a source application database and details of peripheral entity technologies associated with the source application database. In some embodiments, the AUDE uses a combination of various system commands, database technology commands, SQL queries and scripting powered by various algorithms and issues them to a system interface, which is configured to interact with the source infrastructure by issuing the commands, queries, etc., received from the AUDE. The AUDE interprets the outcome of the commands, queries, etc., and builds an exhaustive inventory of the source infrastructure.

In an illustrative embodiment, the AUDE collects source inventory data descriptive of assets included in a source infrastructure. The AUDE includes an entity detection manager that controls a database command module, system command module, script module, search module, and external utility module to perform a series of tasks that iteratively build an exhaustive inventory of a source infrastructure that includes characteristics of an application database and one or more peripheral entities associated with the application database.

In an illustrative embodiment, the entity detection manager instructs the database command module to generate database commands, instructs the system command module to generate system commands, instructs the script module to generate scripts, instructs the search module to generate search queries, and instructs the external utility module to run external utility applications. The database commands from the database command module, system commands from the system command module, scripts from the script module, queries from the search module, and external utility application triggers from the external utility module are sent to the system interface, which is configured to interact with the source infrastructure by issuing the commands, queries, etc., received from the AUDE.

As an example, in the illustrative embodiment, the entity detection manager generates source inventory data about the source application database using characteristic data collected about the source application database. In some embodiments, the entity detection manager instructs the database command module to issue one or more database commands to the source application database. The entity detection manager receives responses to the one or more database commands and extracts characteristic data indicative of one or more characteristics of the source application database. The entity detection manager then appends the characteristic data to the source inventory data stored in the asset inventory memory.

In an illustrative embodiment, the entity detection manager generates source inventory data about the source infrastructure platform using characteristic data collected about an infrastructure platform as a periphery entity of a source infrastructure. In some embodiments, the entity detection manager instructs external utility module to run an infrastructure discovery utility against the infrastructure platform. The entity detection manager receives the results from the infrastructure discovery utility and extracts characteristic data indicative of one or more characteristics of the infrastructure platform from the received results. The entity detection manager then appends the characteristic data to the source inventory data stored in the asset inventory memory.

In an illustrative embodiment, the entity detection manager generates source inventory data about a data storage system using characteristic data collected about the data storage system as a periphery entity of a source infrastructure. In some embodiments, the entity detection manager instructs the system command module to issue one or more system commands to, and/or the script module to run one or more scripts against, the source data storage system. The entity detection manager receives responses to the one or more system commands and/or scripts and extracts characteristic data indicative of one or more characteristics of the source data storage system. The entity detection manager then appends the characteristic data to the source inventory data stored in the asset inventory memory.

In an illustrative embodiment, the entity detection manager generates source inventory data about one or more peripheral entities, such as one or more of an administration system, DevOps system, HA system, security system, database monitoring system, database backup system, and ETL system as a periphery entities of a source infrastructure. The entity detection manager uses characteristic data collected about the one or more peripheral entities to generate the source inventory data . . . . In some embodiments, the entity detection manager instructs the system command module to issue one or more system commands to, and/or the script module to run one or more scripts (e.g., as listed in col. 3 of Table 1) against, and/or the search module to perform one or more searches of, the one or more peripheral entities. The entity detection manager receives responses to the one or more system commands, scripts, and/or searches and extracts characteristic data indicative of one or more characteristics (e.g., such as listed in col. 2 of Table 1) of the one or more peripheral entities. The entity detection manager then appends the characteristic data to the source inventory data stored in the asset inventory memory.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

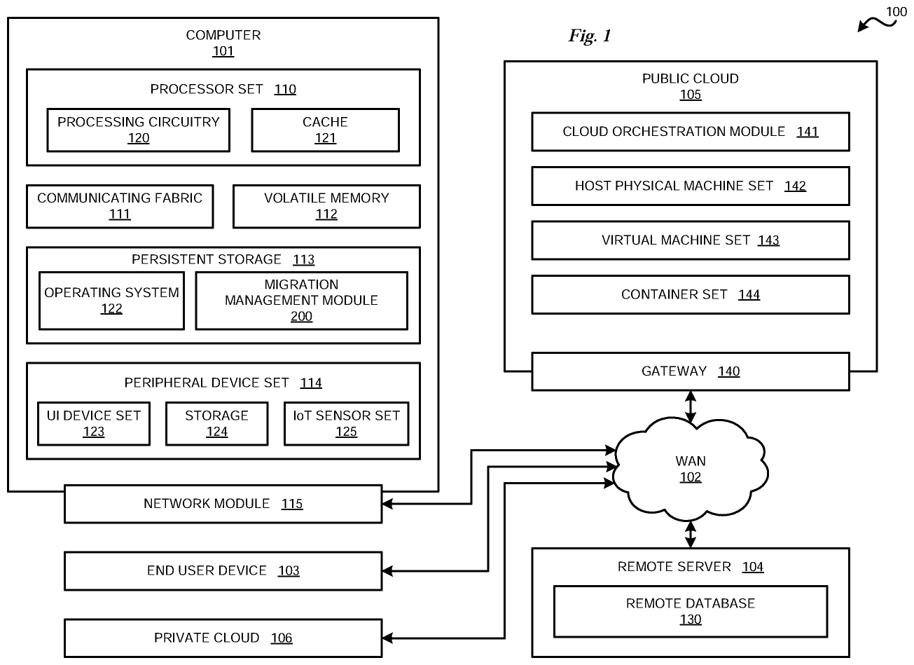

With reference to FIG. 1, this figure depicts a block diagram of a computing environment 100. Computing environment 100 contains an example of an environment for the execution of at least some of the computer code involved in performing the inventive methods, such as an improved migration management module 200 that performs migration planning with automated discovery of source assets. In addition to migration management module 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and migration management module 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in migration management module 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in migration management module 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

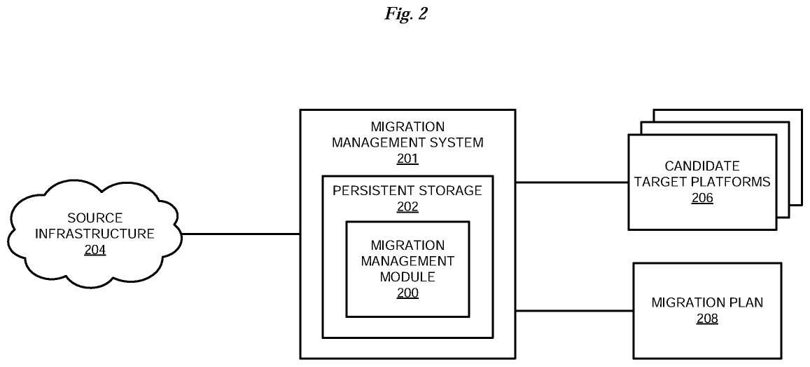

With reference to FIG. 2, this figure depicts a block diagram of an exemplary migration environment for a migration management system 201 in accordance with an illustrative embodiment. The migration management system 201 is a processor-based system, such as a computer or a server. For example, in a particular embodiment, the migration management system 201 is an example of the computer 101 of FIG. 1.

In the illustrated embodiment, the migration management system 201 comprises a persistent storage 202, which in some embodiments is an example of persistent storage 113 of FIG. 1. The persistent storage 202 includes a migration management module 200. In alternative embodiments, the migration management system 201 can include some or all of the functionality described herein but grouped differently into one or more systems or modules. In some embodiments, the functionality described herein is distributed among a plurality of systems, which can include combinations of software and/or hardware-based systems, for example Application-Specific Integrated Circuits (ASICs), computer programs, or smart phone applications.

In some embodiments, the migration management system 201 collects and/or analyzes data from various sources. The migration management system 201 utilizes the data to create a migration plan 208. For example, in some embodiments, the migration management system 201 utilizes the data to identify IT assets of a source infrastructure 204. In some embodiments, the source infrastructure 204 is located at a source site and comprises IT infrastructure of an enterprise. In some embodiments, the migration plan 208 includes instructions for migrating an application database of the source infrastructure 204 from a first computing environment to a second computing environment. For example, in some embodiments, the migration plan 208 includes instructions that define characteristics of a migration of an application database from the source infrastructure 204 to a target platform selected from a plurality of candidate target platforms 206. In some embodiments, the migration plan 208 may be utilized to create an infrastructure topology template for performing the migration and configuring the application and/or workload at the destination computing environment.

In some embodiments, migration management system 201 creates the migration plan 208 using collected data. In some embodiments, the migration management system 201 generates source inventory data representative of IT assets associated with the source infrastructure 204. In some embodiments, the source infrastructure 204 comprises a source application database and one or more source peripheral entities associated with the source application database. In some such embodiments, the migration management system 201 generates source inventory data representative of the source application database and the one or more source peripheral entities.

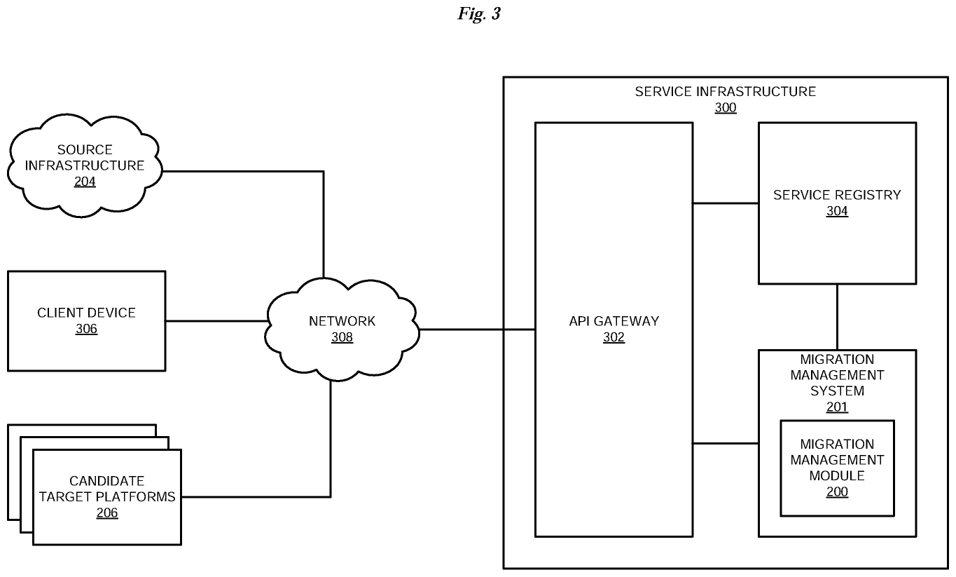

With reference to FIG. 3, this figure depicts a block diagram of an example service infrastructure 300 in accordance with an illustrative embodiment. In the illustrated embodiment, the service infrastructure 300 includes a migration management system 201, which is an example of the computer 101 of FIG. 1.

In the illustrated embodiment, the service infrastructure 300 provides services and service instances from the migration management system 201. A client device 306 communicates with service infrastructure 300 via a network 308 and an API gateway 302. In various embodiments, service infrastructure 300 and its associated migration management system 201 serve multiple users and multiple tenants. A tenant is a group of users (e.g., a company) who share a common access with specific privileges to the software instance. Service infrastructure 300 ensures that tenant specific data is isolated from other tenants.

In the illustrated embodiment, service infrastructure 300 includes a service registry 304. In some embodiments, the migration management system 201 is a virtual machine and the service registry 304 looks up service instances of migration management system 201 in response to a service lookup request such as one from API gateway 302 in response to a service request from the client device 306. In some embodiments, the migration management module 200 collects and/or analyzes data from source infrastructure 204 and the migration management system 201 uses the data to create a migration plan to migrate to a selected one of the candidate target platforms 206 as described in connection with FIG. 2, except that in the embodiment shown in FIG. 3, the data collection and/or migration plan creation by migration management system 201 is responsive to one or more requests from the client device 306 via API calls to the API gateway 302.

In some embodiments, service registry 304 maintains information about the status or health of each service instance including performance information associated each of the service instances. In some such embodiments, such information may include various types of performance characteristics of a given service instance (e.g., cache metrics, etc.) and records of updates.

In some embodiments, the client device 306 connects with API gateway 302 via any suitable network or combination of networks such as the Internet, etc. and uses any suitable communication protocols such as Wi-Fi, Bluetooth, etc. Service infrastructure 300 may be built on the basis of cloud computing. API gateway 302 provides access to client applications like the migration management system 201. API gateway 302 receives service requests issued by client applications and creates service lookup requests based on service requests. As a non-limiting example, in an embodiment, the client device 306 executes a routine to initiate interaction with the migration management system 201. For instance, in some embodiments, a user accesses the migration management module 200 directly using a command line or GUI. Also, in some embodiments, the user accesses the migration management system 201 indirectly through the use of a web application that interacts with the migration management system 201 via the API gateway 302.

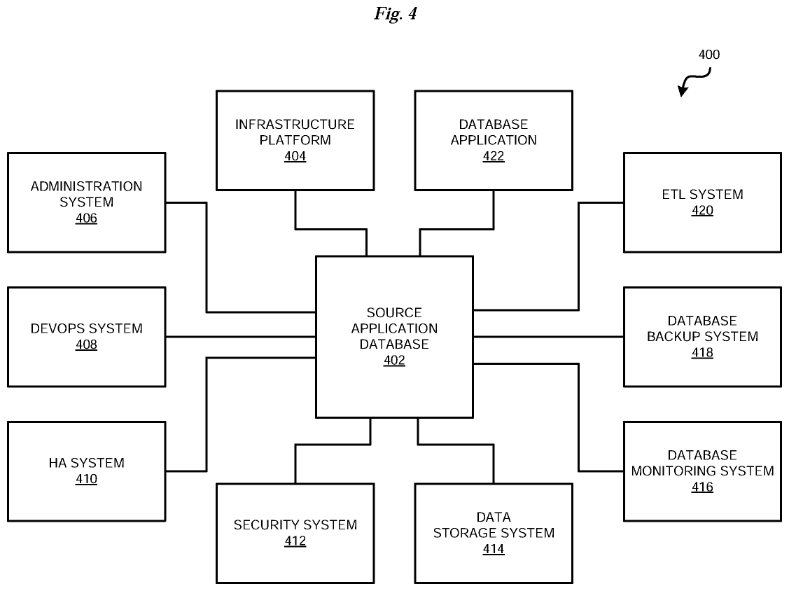

With reference to FIG. 4, this figure depicts a block diagram of an example source infrastructure 400 in accordance with an illustrative embodiment. In a particular embodiment, the source infrastructure 400 is an example of source infrastructure 204 of FIGS. 2 and 3.

Illustrative embodiments of the migration management module 200 may collect and produce a variety of source inventory data descriptive of assets included in a source landscape, where the assets of the source landscape include a source application database and one or more source peripheral entities. The embodiment shown in FIG. 4 includes a source application database 402 and, as non-limiting examples of peripheral entities, an infrastructure platform 404, an administration system 406, a DevOps system 408, an HA system 410, a security system 412, a data storage system 414, a database monitoring system 416, a database backup system 418, an ETL system 420, and a database application 422. Alternative embodiments include only one or more peripheral entities, which may include one or more of the peripheral entities shown in FIG. 4.

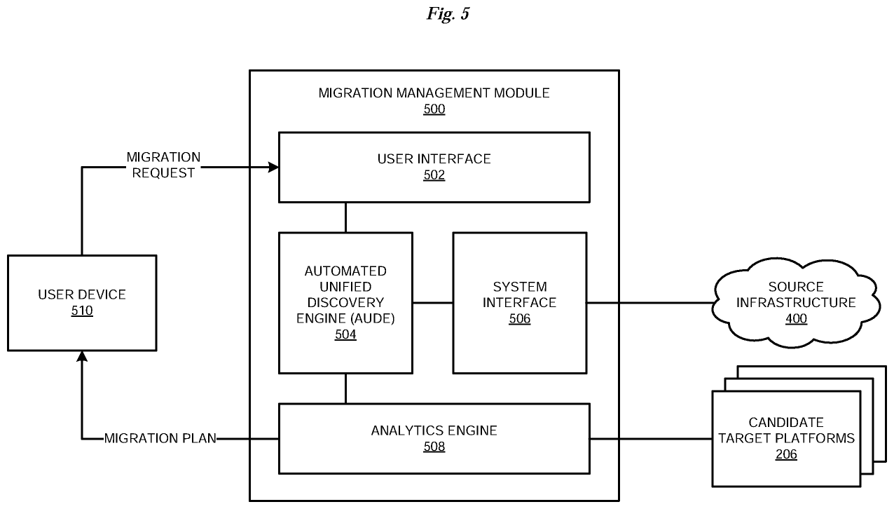

With reference to FIG. 5, this figure depicts a block diagram of a migration management module 500 in accordance with an illustrative embodiment. In a particular embodiment, the migration management module 500 is an example of migration management module 200 of FIGS. 1-3.

In the illustrated embodiment, the migration management module 500 comprises a user interface 502, an automated unified discovery engine (AUDE) 504, a system interface 506, and an analytics engine 508. In alternative embodiments, the migration management module 500 can include some or all of the functionality described herein but grouped differently into one or more systems or modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, a user device 510 initiates a migration process by issuing a migration request that is received by the user interface 502 of the migration management module 500. Responsive to the migration request, the AUDE 504 collects source inventory data descriptive of assets included in the source infrastructure 400. The source inventory data may include details of implemented features of the source application database 402 and details of peripheral entity technologies, such as those shown in FIG. 4. In some embodiments, the AUDE 504 uses a combination of various system commands, database technology commands, SQL queries and scripting powered by various algorithms and issues them to the system interface 506, which is configured to interact with the source infrastructure 400 by issuing the commands, queries, etc., received from the AUDE 504. The AUDE 504 interprets the outcome of the commands, queries, etc., and builds an exhaustive inventory of the source infrastructure 400. Using the peripheral entities shown in FIG. 4 as an example, Table 1 below shows examples of characteristic data that is collected and collection techniques for each of the example peripheral entities.

TABLE 1

| Asset Category | Data Collected | Method of Collecting Data |
|---|---|---|
| Application Database | Version | Custom script calling |
| | Edition | Commands - e.g., db2stat, |
| | License Info | db2level, db2ls and SQL queries |
| | Data Volume | on System catalog tables and a |
| | Database Configuration | parser and an interpreter |
| | Storage, CPU, memory | |
| | Database Performance | |
| | Statistics-how many | |
| | transactions per sec | |
| | Database Objects definition | |
| | Schemas | |
| | Tablespaces | |
| | Table Types (temporary, | |
| | timestamp) | |
| | Index Types | |
| | Constraints | |
| | Views | |
| | Identity Columns | |
| | Stored Procedure | |
| | Triggers | |
| | Functions | |
| | Data Types | |
| | Which product-specific | |
| | features are being used e.g., | |
| | cascade delete, sequencing, | |
| | temporary tables, indexed | |
| | tables, etc. | |
| | Stored Procedures (non- | |
| | ANSI SQL statements e.g., | |
| | Merge/upsert) | |
| | Page size (2K, 4K, 8K) | |
| | Database Code language | |
| | e.g., DB2 written C++ | |
| infrastructure | BareMetal/Virtual Machine | IBM Galapagos utility |
| platform | Configuration of the system - | |
| | CPU, RAM, HDD | |
| | Operating System - version, | |
| | edition | |
| | Network speed | |
| data storage system | Type of Storage | Custom script calling various |
| | Volumes | system commands and |
| | Storage configuration - | parsing the information from |
| | RAID, how many slots used | output of each command. |
| | and free. | e.g.: iostat, db2listvolumes |
| | IOPS | |
| security system | Identify security features | Custom SQL Query on |
| | implemented at DB level. | System Catalog |
| | e.g., Audit trail, RBAC, | Custom Script to read |
| | column encryption, | configuration files & identify |
| | encryption | third party tools. |
| | Third party tool used to | Database commands |
| | implement security | e.g.: db2credman, |
| | featured. | db2gateways, db2ldcfg |
| | e.g., Guardium for | |
| | encryption, audit trail or | |
| | IAM | |
| administration system | Identify the open source and | Custom script calling various |
| | third-party tools and | system commands e.g.: |
| | utilities used. | db2pd, crontab -a, db2iauto, |
| | Identify language and | db2top, db2expln |
| | number of custom | |
| | administration scripts. | |
| | Identify OTB features and | |
| | utilities used from the | |
| | product. | |
| | Type & schedule of | |
| | maintenance activities | |
| | performed. | |
| | e.g., runstat, db restarts, | |
| | backup. | |
| | Database features used for | |
| | running maintenance | |
| | activities. | |
| | e.g., runstat query, db start | |
| DevOps system | Tools used for Source Code | Custom script calling various |
| | Management | commands. |
| | e.g.: Git, ClearCase | Custom script to discover |
| | Tools used for performing | DevOps tools used. |
| | for Code Scan | e.g.: git -version, sudo |
| | e.g.: SonarQube | systemctl status jenkins |
| | Tools used for Defect | Custom code to interpret log |
| | tracking | files, slack and emails. |
| | e.g.: JIRA | Custom code to interpret |
| | Tools used for Code Build | SCM repos, CI-CD pipelines |
| | e.g.: Maven | Custom code to filter tools by |
| | Tools used for automated | open source or license |
| | testing and validation | information |
| | e.g.: Selenium | |
| | Tools used for orchestration | |
| | and deployment of CI-CD | |
| | pipelines | |
| | e.g.: Jenkins | |
| database application | Identify the type of | Custom code to search and |
| | application consuming and | match application code from |
| | processing the database - | system catalog tables e.g.: |
| | OLAP, OLTP, BigData | SYSDEFAULTUSERWORKLOAD, |
| | (Spark, python) | SYSCAT.WORKLOADCONNATTR |
| | Code language | Custom code to interpret the |
| | Monolithic or microservices | workload on worker nodes. |
| | based | e.g.: kubectl, yaml files, |
| | | config maps |
| | | Custom code to search in Git |
| | | repositories. |
| | | e.g.: git grep |
| | | Custom code to search in CI- |
| | | CD pipelines. |
| | | e.g.: groovy script, find/exec/cp |
| ETL system | Identify the framework and | Custom code to discover the |
| | technology used. | ETL tools used. |
| | Number of jobs running in | e.g.: ./bin/uv -admin - |
| | crontab | version |
| | | Custom code to interpret log |
| | | files and jobs |
| database monitoring | Identify the tools and | Custom code to look for |
| | technologies used for | processes associated with |
| | monitoring systems. | monitoring tools. |
| | Identify the KPIs being | e.g.: ps -ef \| grep nagios, |
| | monitored. | /usr/local/groundwork/ |
| | Identify the types of | grafana/bin/grafana-server-v |
| | monitoring performed - | Custom code to interpret log |
| | Availability, Performance, | files, slack and emails |
| | Transactional | Interpret the output of |
| | Identify the alerting | visualizations. |
| | mechanism. | Manual data collection from |
| | Identify the notification | visualizations |
| | method | Manual data collection |
| | | through queries |
| | | e.g.: db2caem |
| HA system | Identify the tools and | Interpretation of system host |
| | technologies used for HA | entries |
| | configuration. | e.g.: /etc/hosts, db2nodes.cfg |
| | HA configuration - Active- | Interpretation of password |
| | Passive, Active-Active | ssh log entries |
| | Replication configuration | e.g.: /etc/ssh/sshd_config |
| | (if applicable) - Change | Database commands |
| | Data Capture - SQL, MQ | e.g.: db2cluster, db2cptsa |
| | based | |
| backup system | Identify the tools and | Custom code to find the |
| | technologies used for | code associated with backup |
| | backup. | tools. |
| | Backup configuration | e.g.: db2adutl, dsm.sys, |
| | Backup mode - online, | dsm.opt |
| | offline, full, incremental, | Interpretation of output logs |
| | delta | through custom code |
| | Backup schedule | Interpretation of backup |
| | Last backup status | scripts & schedules |
| | | e.g.: db2 backup DB <>, |
| | | crontab -a, db2 get db cfg |
| | | \| grep |
| | | LOGARCHMETH1, |
| | | db2ckbkp |

The AUDE 504 provides the source inventory data to the analytics engine 508 for generation of a migration plan. The analytics engine 508 selects at least one prospective target platform from among the candidate target platforms 206 for migration evaluation. In some embodiments, the migration evaluation is based on one or more of an evaluation of the source infrastructure 400, requirements or constraints imposed by a user, and compatibility and affinity of the candidate target platform.

In some embodiments, the analytics engine 508 determines compatibilities of the peripheral entities (identified by the AUDE 504) with the candidate target platform. In some embodiments, the analytics engine 508 determines compatibility using known techniques. For example, in an embodiment, the analytics engine 508 determines compatibility by scanning a look-up table that stores compatibility information between various hardware components, operating systems, software, and databases. The analytics engine 508 determines a degree of compatibility for the candidate target platform based on the results of the compatibility determinations for each of the peripheral entities. The analytics engine 508 uses this degree of compatibility to generate an overall compatibility score for the candidate target platform.

In some embodiments, the analytics engine 508 repeats this process for each of the candidate target platforms 206, resulting in a set of overall compatibility scores for each of the candidate target platforms 206. The analytics engine 508 then compares the overall compatibility scores to identify a target platform from among the candidate target platforms 206 that is most compatible with the source infrastructure 400. In some embodiments, the analytics engine 508 then generates a migration plan \defining characteristics of a migration of the source infrastructure 400 to the selected target platform.

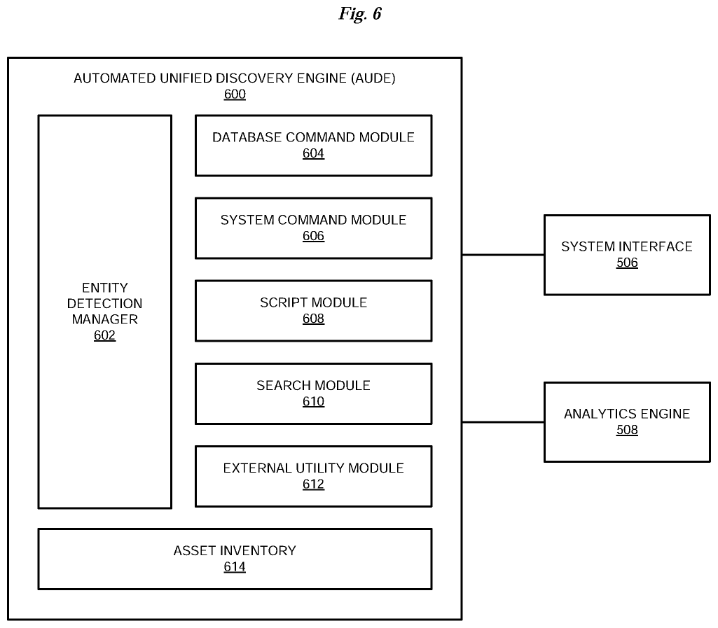

With reference to FIG. 6, this figure depicts a block diagram of an automated unified discovery engine (AUDE) 600 in accordance with an illustrative embodiment. In a particular embodiment, the AUDE 600 is an example of AUDE 504 of FIG. 5.

In the illustrated embodiment, the AUDE 600 comprises an entity detection manager 602, a database command module 604, a system command module 606, a script module 608, a search module 610, an external utility module 612, and a memory for storing an asset inventory 614. In alternative embodiments, the AUDE 600 can include some or all of the functionality described herein but grouped differently into one or more systems or modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the AUDE 504 collects source inventory data descriptive of assets included in a source infrastructure, such as the source infrastructure 400. The AUDE 504 includes an entity detection manager 602 that controls the database command module 604, system command module 606, script module 608, search module 610, and external utility module 612 to perform a series of tasks that iteratively build an exhaustive inventory of a source infrastructure that includes characteristics of an application database and one or more peripheral entities associated with the application database.

In an exemplary embodiment, the entity detection manager 602 instructs the database command module 604 to generate database commands, instructs the system command module 606 to generate system commands, instructs the script module 608 to generate scripts, instructs the search module 610 to generate search queries, and instructs the external utility module 612 to run external utility applications. The database commands from the database command module 604, system commands from the system command module 606, scripts from the script module 608, queries from the search module 610, and external utility application triggers from the external utility module 612 are sent to the system interface 506, which is configured to interact with the source infrastructure 400 by issuing the commands, queries, etc., received from the AUDE 504.

Referring to the source infrastructure 400 of FIG. 4 as an example, in the illustrated embodiment, the entity detection manager 602 generates source inventory data about the source application database 402 using characteristic data collected about the source application database 402. In some embodiments, the entity detection manager 602 instructs the database command module 604 to issue one or more database commands (e.g., as listed in col. 3 of Table 1) to the source application database 402. The entity detection manager 602 receives responses to the one or more database commands and extracts characteristic data indicative of one or more characteristics (e.g., such as listed in col. 2 of Table 1) of the source application database 402. The entity detection manager 602 then appends the characteristic data to the source inventory data stored in the asset inventory 614 memory.

In the illustrated embodiment, the entity detection manager 602 generates source inventory data about the source infrastructure platform 404 using characteristic data collected about the infrastructure platform 404. In some embodiments, the entity detection manager 602 instructs external utility module 612 to run an infrastructure discovery utility (e.g., as listed in col. 3 of Table 1) against the infrastructure platform 404. The entity detection manager 602 receives the results from the infrastructure discovery utility and extracts characteristic data indicative of one or more characteristics (e.g., such as listed in col. 2 of Table 1) of the infrastructure platform 404 from the received results. The entity detection manager 602 then appends the characteristic data to the source inventory data stored in the asset inventory 614 memory.

In the illustrated embodiment, the entity detection manager 602 generates source inventory data about the data storage system 414 using characteristic data collected about the data storage system 414. In some embodiments, the entity detection manager 602 instructs the system command module 606 to issue one or more system commands to, and/or the script module 608 to run one or more scripts (e.g., as listed in col. 3 of Table 1) against, the source data storage system 414. The entity detection manager 602 receives responses to the one or more system commands and/or scripts and extracts characteristic data indicative of one or more characteristics (e.g., such as listed in col. 2 of Table 1) of the source data storage system 414. The entity detection manager 602 then appends the characteristic data to the source inventory data stored in the asset inventory 614 memory.

In the illustrated embodiment, the entity detection manager 602 generates source inventory data about one or more peripheral entities, such as one or more of the administration system 406, DevOps system 408, HA system 410, security system 412, database monitoring system 416, database backup system 418, ETL system 420, and database application 422 using characteristic data collected about the one or more peripheral entities. In some embodiments, the entity detection manager 602 instructs the system command module 606 to issue one or more system commands to, and/or the script module 608 to run one or more scripts (e.g., as listed in col. 3 of Table 1) against, and/or the search module 610 to perform one or more searches of, the one or more peripheral entities. The entity detection manager 602 receives responses to the one or more system commands, scripts, and/or searches and extracts characteristic data indicative of one or more characteristics (e.g., such as listed in col. 2 of Table 1) of the one or more peripheral entities. The entity detection manager 602 then appends the characteristic data to the source inventory data stored in the asset inventory 614 memory.

In some embodiments, the script module 608 runs a script for determining characteristic data of a peripheral entity where the script includes reading and extracting information from a configuration file associated with the peripheral entity and the response includes at least a portion of the configuration file. In some embodiments, the entity detection manager 602 extracts characteristic data indicative of one or more characteristics of the security system 412. The entity detection manager 602 then appends the characteristic data to the source inventory data stored in the asset inventory 614 memory.

In some embodiments, the system command module 606 and/or script module 608 issues a system command or runs a script for determining characteristic data of a peripheral entity where the command or script includes reading and extracting information from a log file associated with the peripheral entity and the response includes at least a portion of the log file. In some embodiments, the entity detection manager 602 extracts characteristic data indicative of one or more characteristics of one or more of the DevOps system 408, the ETL system 420, the HA system 410, the database monitoring system 416, and/or the database backup system 418. The entity detection manager 602 then appends the characteristic data to the source inventory data stored in the asset inventory 614 memory.

In some embodiments, the system command module 606 and/or script module 608 issues a system command or runs a script for determining characteristic data of a peripheral entity where the command or script includes reading and extracting information from a hosts file associated with the peripheral entity and the response includes at least a portion of the hosts file. In some embodiments, the entity detection manager 602 extracts characteristic data indicative of one or more characteristics of the HA system 410. The entity detection manager 602 then appends the characteristic data to the source inventory data stored in the asset inventory 614 memory.

In some embodiments, the system command module 606 and/or script module 608 issues a system command or runs a script for determining characteristic data of a peripheral entity where the command or script includes reading and extracting information from a system catalog table associated with the peripheral entity and the response includes, or is based at least in part on, at least a portion of the system catalog table. In some embodiments, the entity detection manager 602 extracts characteristic data indicative of one or more characteristics of the source application database 402, security system database application 412, and database application 422. The entity detection manager 602 then appends the characteristic data to the source inventory data stored in the asset inventory 614 memory.

In some embodiments, the system command module 606 and/or script module 608 issues a system command or runs a script for determining characteristic data of a peripheral entity where the command or script includes identifying at least one process that is running on the data storage system 414 and is associated with the peripheral entity, and where the response is based at least in part on the identified process. In some embodiments, the entity detection manager 602 extracts characteristic data indicative of one or more characteristics of the database monitoring system 416. The entity detection manager 602 then appends the characteristic data to the source inventory data stored in the asset inventory 614 memory.

In some embodiments, the system command module 606 and/or script module 608 issues a system command or runs a script for detecting licensing information for a license associated with the peripheral entity, and the response includes at least a portion of the licensing information, and the characteristic data indicates whether the license is an open source license. In some embodiments, the entity detection manager 602 extracts characteristic data indicative of one or more characteristics of the source application database 402 and DevOps system 408. The entity detection manager 602 then appends the characteristic data to the source inventory data stored in the asset inventory 614 memory.

In some embodiments, the system command module 606 and/or script module 608 issues a system command or runs a script for performing a search of a source code repository, and the response includes at least a portion of the source code repository returned responsive to the search. In some embodiments, the entity detection manager 602 extracts characteristic data indicative of one or more characteristics of the DevOps system 408. The entity detection manager 602 then appends the characteristic data to the source inventory data stored in the asset inventory 614 memory.

In some embodiments, the system command module 606 and/or script module 608 issues a system command or runs a script for performing a search of a continuous integration/continuous delivery (CI/CD) pipeline, and the response includes at least a portion of the CI/CD pipeline returned responsive to the search. In some embodiments, the entity detection manager 602 extracts characteristic data indicative of one or more characteristics of the database application 422. The entity detection manager 602 then appends the characteristic data to the source inventory data stored in the asset inventory 614 memory.

The AUDE 504 provides the source inventory data to the analytics engine 508 for generation of a migration plan. In some embodiments, the analytics engine 508 has access to the asset inventory 614 while the AUDE 600 is collecting the characteristic data and begins performing compatibility tests using characteristic data as it becomes available. Alternatively, the AUDE 600 notifies the analytics engine 508 when the discovery of source assets is completed and provides the asset inventory data, or access to the asset inventory data, to the analytics engine 508.

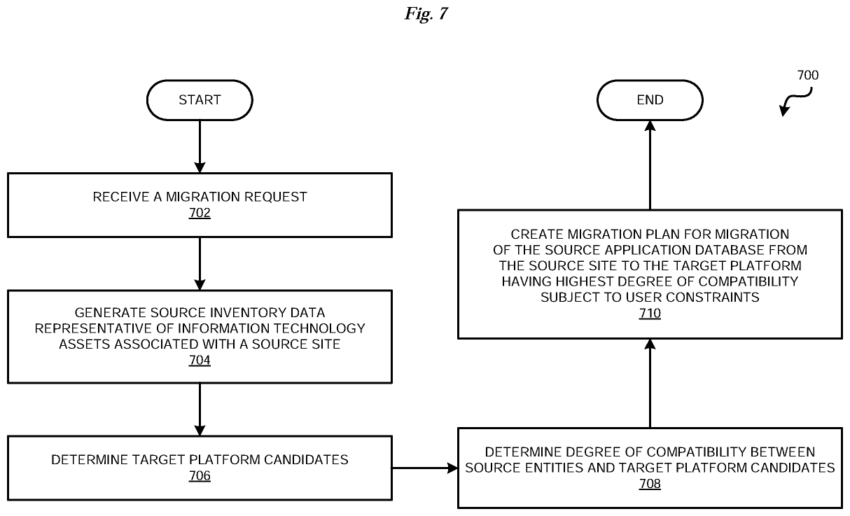

With reference to FIG. 7, this figure depicts a flowchart of an example process 700 for migration planning with automated discovery of source assets in accordance with an illustrative embodiment. In a particular embodiment, the migration management system 201 carries out the process 700.

At block 702, the process receives a migration request. Next, at block 704, the process generates source inventory data representative of information technology assets associated with a source site. Next, at block 706, the process determines target platform candidates. Next, at block 708, the process determines a degree of compatibility between source entities and target platform candidates. Next, at block 710, the process creates a migration plan for migration of the source application database from the source site to the target platform having highest degree of compatibility subject to user constraints.

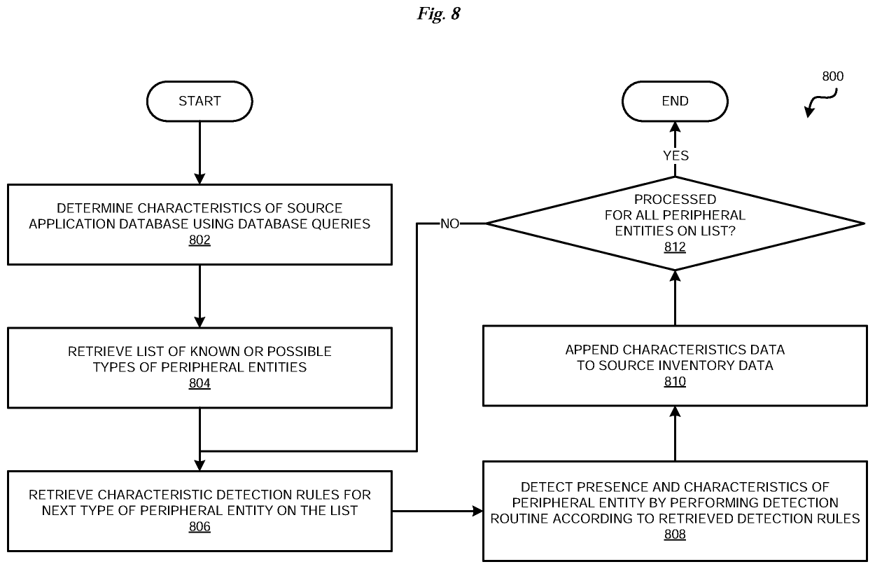

With reference to FIG. 8, this figure depicts a flowchart of an example process 800 for automated discovery of source assets in accordance with an illustrative embodiment. In a particular embodiment, the migration management module 200 carries out the process 800.

At block 802, the process determines characteristics of a source application database using database queries. Next, at block 804, the process retrieves a list of known or possible types of peripheral entities associated with the source application database. Next, at block 806, the process retrieves characteristic detection rules for a next type of peripheral entity on the list, where for the first iteration, the first type is the “next type,” then for the second iteration the second type is the “next type,” and so on until each type of peripheral entity on the list has been processed.

Next, at block 808, the process detects the presence and characteristics of peripheral entity by performing a detection routine according to retrieved detection rules. Next, at block 810, the process appends the characteristics data to source inventory data. Next, at block 812, the process determines whether all peripheral entities on the list have been processed. If not, then the process returns to block 806. Otherwise, if so, then the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (Saas) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
generating source inventory data representative of information technology assets associated with a source site, the source site comprising information technology infrastructure of an enterprise, the information technology assets comprising a source application database and a source peripheral entity associated with the source application database;
determining a target platform for migrating the source application database;
determining a degree of compatibility between the source peripheral entity and the target platform; and
creating, by a processor-based migration management system, a migration plan defining characteristics of a migration of the source application database from the source site to the target platform, wherein the target platform is selected from among a plurality of candidate target platforms based at least in part on the degree of compatibility between the source peripheral entity and the target platform.

2. The computer-implemented method according to claim 1, wherein the generating of the source inventory data comprises:
issuing a database command to the source application database;
receiving a response to the database command from the source application database;
extracting, from the response, characteristic data indicative of a characteristic of the source application database; and
appending the characteristic data to the source inventory data.

3. The computer-implemented method according to claim 1, wherein the source peripheral entity is a source infrastructure platform, and wherein the generating of the source inventory data comprises:
extracting characteristic data indicative of the source infrastructure platform from an output of an infrastructure discovery utility; and
appending the characteristic data to the source inventory data.

4. The computer-implemented method according to claim 1, wherein the source peripheral entity is a source data storage system hosting the source application database, and wherein the generating of the source inventory data comprises:
issuing a system command to the source data storage system;
receiving a response to the system command from the source data storage system;
extracting, from the response, characteristic data indicative of a characteristic of the source data storage system; and
appending the characteristic data to the source inventory data.

5. The computer-implemented method according to claim 1, wherein the generating of the source inventory data comprises:
issuing a system command to a source data storage system hosting the source application database;
receiving a response to the system command from the source data storage system;
extracting, from the response, characteristic data indicative of a characteristic of the source peripheral entity; and
appending the characteristic data to the source inventory data.

6. The computer-implemented method according to claim 5, wherein the source peripheral entity is selected from the group consisting of a data security system, a database administration system, a development and operations (DevOps) system, a database application, an extract, transform, and load (ETL) system, a database monitoring system, a database high-availability system, and a database backup system.

7. The computer-implemented method according to claim 5, wherein the system command is part of a script configured to read a configuration file, and wherein the response comprises at least a portion of the configuration file.

8. The computer-implemented method according to claim 5, wherein the system command is part of a script configured to read a log file, and wherein the response comprises at least a portion of the log file.

9. The computer-implemented method according to claim 5, wherein the response comprises at least one process running on the source data storage system.

10. The computer-implemented method according to claim 5, wherein the system command is part of a script configured to read a system hosts file, and wherein the response comprises at least a portion of the hosts file.

11. The computer-implemented method according to claim 5, wherein the system command is part of a script configured to read a system catalog table, and wherein the response comprises at least a portion of the system catalog table.

12. The computer-implemented method according to claim 5, wherein the system command is part of a script configured to detect licensing information for a license associated with the peripheral entity, wherein the response comprises at least a portion of the licensing information, and wherein the characteristic data indicates whether the license is an open source license.

13. The computer-implemented method according to claim 5, wherein the system command is part of a script configured to perform a search of a source code repository, and wherein the response comprises at least a portion of the source code repository returned responsive to the search.

14. The computer-implemented method according to claim 5, wherein the system command is part of a script configured to perform a search of a continuous integration/continuous delivery (CI/CD) pipeline, and wherein the response comprises at least a portion of the CI/CD pipeline returned responsive to the search.

15. A computer program product comprising one or more computer readable storage media, and program instructions collectively stored on the one or more computer readable storage media, the program instructions executable by a processor to cause the processor to perform operations comprising:
generating source inventory data representative of information technology assets associated with a source site, the source site comprising information technology infrastructure of an enterprise, the information technology assets comprising a source application database and a source peripheral entity associated with the source application database;
determining a target platform for migrating the source application database;
determining a degree of compatibility between the source peripheral entity and the target platform; and
creating, by a processor-based migration management system, a migration plan defining characteristics of a migration of the source application database from the source site to the target platform, wherein the target platform is selected from among a plurality of candidate target platforms based at least in part on the degree of compatibility between the source peripheral entity and the target platform.

16. The computer program product of claim 15, wherein the stored program instructions are stored in a computer readable storage device in a data processing system, and wherein the stored program instructions are transferred over a network from a remote data processing system.

17. The computer program product of claim 15, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

18. The computer program product of claim 15, wherein the generating of the source inventory data comprises:
issuing a database command to the source application database;
receiving a response to the database command from the source application database;
extracting, from the response, characteristic data indicative of a characteristic of the source application database; and
appending the characteristic data to the source inventory data.

19. A computer system comprising a processor and one or more computer readable storage media, and program instructions collectively stored on the one or more computer readable storage media, the program instructions executable by the processor to cause the processor to perform operations comprising:
generating source inventory data representative of information technology assets associated with a source site, the source site comprising information technology infrastructure of an enterprise, the information technology assets comprising a source application database and a source peripheral entity associated with the source application database;
determining a target platform for migrating the source application database;
determining a degree of compatibility between the source peripheral entity and the target platform; and
creating, by a processor-based migration management system, a migration plan defining characteristics of a migration of the source application database from the source site to the target platform, wherein the target platform is selected from among a plurality of candidate target platforms based at least in part on the degree of compatibility between the source peripheral entity and the target platform.

20. The computer system of claim 19, wherein the generating of the source inventory data comprises:
issuing a database command to the source application database;
receiving a response to the database command from the source application database;
extracting, from the response, characteristic data indicative of a characteristic of the source application database; and
appending the characteristic data to the source inventory data.
